(19) United States
(12) Patent Application Publication
(10) Pub. No.: US 2016/0282553 A1
(43) Pub. Date: Sep. 29, 2016

(54) OPTICAL FIBER WITH MOSAIC FIBER

(71) Applicant: IPG PHOTONICS CORPORATION, Oxford, MA (US)

(72) Inventors: Valentin GAPONTSEV, Worcester, MA (US); Igor SAMARTSEV, Westborough, MA (US)

(21) Appl. No.: 15/165,297

(22) Filed: May 26, 2016

Related U.S. Application Data
(63) Continuation of application No. PCT/US2014/063397, filed on Oct. 31, 2014.
(60) Provisional application No. 61/909,060, filed on Nov. 26, 2013.

(51) Int. Cl. G02B 6/02; H01S 3/067; H01S 3/094; H01S 3/16; G02B 6/024; G02B 6/032

(52) U.S. Cl. CPC G02B 6/02314; G02B 6/02009; G02B 6/024; G02B 6/032; H01S 3/094019; H01S 3/1603; H01S 3/06716; H01S 3/06729

(57) ABSTRACT

An optical fiber includes a monolithic elongated mosaic core having a longitudinal axis and configured with a silica-based medium with a uniform refractive index, and a plurality of coaxial elongated individual elements which do not waveguide light at a given wavelength and are received in the silica-glass medium. The refractive indices of the medium and individual anti- waveguiding elements together determine a cumulative effective refractive index of the mosaic core. The optical fiber further includes at least one cladding surrounding the mosaic core and provided with a cladding refractive index which is lower than the index of the mosaic core, so that the mosaic core waveguides the light at the given wavelength.

### BACKGROUND OF THE DISCLOSURE

1. Field of the Disclosure

The disclosure relates to an optical fiber configured with a plurality of optical components which are selectively coupled together to define the fiber's composite mosaic core with a controllable refractive index. More specifically, the disclosure relates to optical fibers configured with the desired refractive index and dopant profiles.

2. Discussion of Prior Art

There exist several methods of manufacturing optical fibers. However, the procedure always includes first preparing a preform, i.e. a rod of vitreous silica of very high purity, and then drawing the fiber from the preform. A variety of light non-amplifying dopants are added to modify the refractive index of the base silica. The selection of non-amplifying dopants depends on the desired index difference. For example, boron and fluorine can be used to reduce the refractive index of silica, while phosphorous and germanium can be used to increase it.

Active optical fibers are obtained by doping the silica with ions of rare earth elements, e.g. erbium (Er), ytterbium (Yb), neodymium (Nd), holmium (Ho), samarium (Sm), thulium (Tm) and others. These dopants are generally used together with another dopant, such as phosphate or alumina, for the purpose of minimizing the phenomenon of rare earth ions “clustering” well known to one of ordinary skill.

The efficiency of active optical fibers depends on interaction between light and matter. The efficiency can be increased in two ways. Firstly, by increasing energy density in the core of the optical fiber by reducing its diameter. This makes it necessary to have a large index difference and a high concentration of dopants other than rare earth ions. Alternatively, interaction between light and matter can be improved by confining the rare earth ions in the small central region of the core, i.e. designing the desired dopant profile.

A problem then arises of the dopant diffusion which makes it difficult to obtain the above-mentioned objectives. In a widely used technique of internal modified chemical vapor deposition (MCVD), the diffusion problem manifests itself practically throughout the process including fiber drawing stages. While MCVD has many advantages over other methods, one of ordinary skill in fiber fabrication is well aware that, using this method, it is difficult to provide the desired refractive index profile in all types of fibers and, particularly, in active fibers and with a low refractive index difference. For example, the step index profile is often characterized by a uniform refractive index within the core. The reality is that, typically, the core refractive index varies and varies significantly, as diagrammatically shown in FIG. 1. As a consequence, the difference An between indices of respective core (ncore) and cladding (nclad) is not uniform. In a multicore structure of FIG. 2 each element waveguides light, and therefore multiple refractive indices each have the same undesirable wave-like character. The non-uniformity has a mass of undesirable consequences including, but not limited to substantial splice losses particularly between MM fibers and the deterioration of beam quality due to the mode coupling phenomenon.

A need therefore exists for a technology that can provide an easy and effective control of the refractive index profile in fiber manufacturing.

The single preform has the length of just a few tens of centimeters and diameter not exceeding a few centimeters. The drawing of fiber from such a preform is very time consuming, and the process output is limited by a relatively short fiber length not exceeding several meters.

Accordingly, another need exists for a technology that allows the fabrication of individual fibers in a time-efficient manner.

Along with the refractive index profile, a doping spatial profile is very important to all fibers and particularly, active multimode (“MM”) fibers. Depending on the doping profile, which can be characterized, among others, by a doping radius and location of dopants within the fiber core, the fiber may be specifically tailored to amplify, for example, a fundamental mode or other selective modes, while suppressing or at least not amplifying other modes. An exemplary structure illustrating the latter may be configured with a central region of MM core heavily doped with ions that partake in amplifying predominantly a fundamental mode at a given wavelength, while doping the core periphery with another type of ions that typically suppress higher order modes at the same wavelength. However, as known to one of ordinary skill in the fiber laser art, very few different types of ions can productively coexist in the same core and, as discussed above, control of the ion deposition is far from being simple and particularly effective.

Hence another need exists for a simple, effective technique that allows controllably forming the desired dopant profile in optical fibers.

Referring specifically to MM active fibers configured to emit output in a fundamental mode, it is known that the scalability of such fibers is limited by the onset of nonlinear effects (“NLE”). One well-known way to reduce the consequences of NLE is to increase a mode area while lowering the core numerical aperture (NA) and increasing the core diameter. In general, this type of fibers is known in the art as large mode area (“LMA”) fibers. Achieving single mode operation then requires modal discrimination techniques, such as bend loss. But for large core and low NA, bending deforms the mode field distribution and reduces the mode area.

Thus, a further need exists for the fibers with a large mode area that are less sensitive to bending stresses prevalent with LMA fibers.

### SUMMARY OF THE DISCLOSURE

The above and other needs are satisfied by the disclosed here structure. The disclosed fiber, like any typical optical fiber, is configured with a core and at least one cladding surrounding the core and having a refractive index lower than that of the core.

The inventive concept relates to the core produced by controllably arranging and coupling together individual components into the desired pattern. Consequently, the thus produced structure is further referred to as a mosaic core.

The components each are configured with a silica-glass medium that has an inner region. The coupling of components to one another produces a matrix, i.e., the cumulative mass of silica-glass medium with embedded therein spaced apart elements which correspond to respective central regions of individual components. The individual components may be selected to have different or uniform physical properties and geometries which together provide the mosaic core with the desired cumulative refractive index.

In accordance with one aspect of the inventive concept, the elements of the mosaic core each are dimensioned to not waveguide light at a given wavelength. Accordingly, as light is coupled into these none-waveguiding elements, it cannot propagate therealong and bleeds into and further guided through the silica-glass medium of the mosaic core. The refractive index of silica-glass is a well-defined step with the top that is substantially more flat, which is desired because of the repeatable uniformity of the index differential, than that of a standard core doped, for example, with light amplifying ions or emitters. The desired refractive index profile, i.e., the difference between refractive indices of respective composite silica-glass-based core and silica-glass-based outer cladding can be easily realized by providing, for example, the cladding with the desired concentration of non-amplifying dopants.

In accordance with another aspect of the inventive concept, individual components may be doped with light amplifying ions of rare earth elements or light non-amplifying ions or with a combination of these. Controllably arranging the components in the predetermined pattern can provide the mosaic core with the desired dopant profile. Thus, the components may be arranged so that elements doped with ions of rare earth elements are concentrated in a specific area of the mosaic core. With the predetermined topography of the dopant profile, the mosaic core is configured to provide the desired gain for selective transverse modes, if the core supports propagation of multiple transverse modes while other high order modes are suppressed.

### BRIEF DESCRIPTION OF THE DRAWINGS

The above and other aspects and features of the invention will become more readily apparent from the following specific description accompanied by the drawings, in which:

FIG. 1 illustrates a refractive step index profile of standard fibers,

FIG. 2 illustrates a refractive profile of known multicore fibers;

FIG. 3 is a computer shot of the inventive optical fiber.

FIGS. 4A-4C illustrate preliminary steps of fiber manufacturing technique in accordance with the invention;

FIGS. 5A-5B illustrate final steps of the inventive technique of FIGs.4A-4CB.

FIG. 6 is an exemplary refractive step index profile of the disclosed fiber;

FIGS. 7 and 8 are respective examples of the refractive index profile of the inventive fiber.

FIG. 9 is a diagrammatic view of an exemplary fiber laser system utilizing the disclosed fiber; and

FIG. 10 is a diagrammatic view of the disclosed mosaic core having a double bottleneck- shaped cross-section.

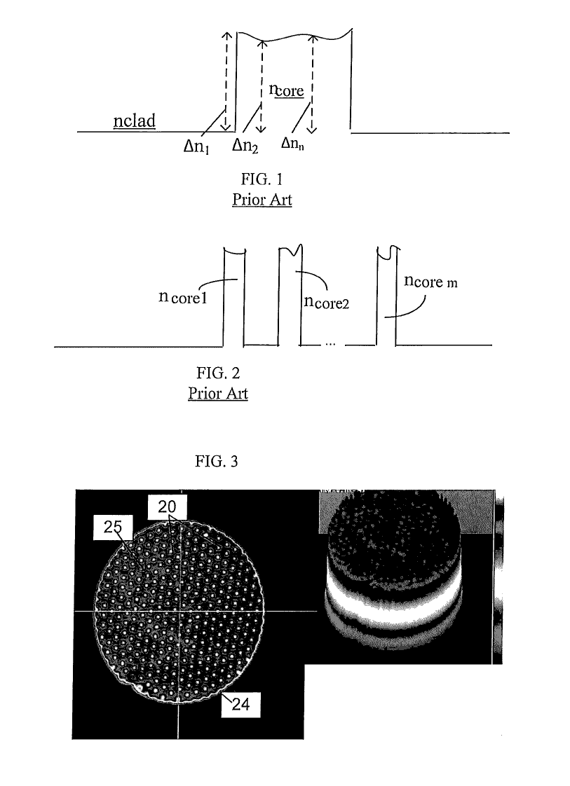

### SPECIFIC DESCRIPTION

The inventive concept underlying the disclosed fiber allows one of ordinary skill in the laser arts to configure an optical fiber with practically any desired refractive index profile. In addition to the desired refractive index profile, based on the inventive concept, an optical fiber may be provided with any desired dopant profile. The optical fiber configured in accordance with the inventive concept may support propagation of single mode (“SM”) or multiple modes (“MM”) and be passive or active.

Referring to FIG. 3, as one of ordinary skill in the fiber manufacturing knows, typically, prior to the beginning of the fiber manufacturing process, the desired numerical aperture (“NA”), core diameter and wavelengths are known. These pieces of information are sufficient to calculate all necessary parameters of the final product. In accordance with the inventive concept, the final product is an optical fiber 10 configured with a mosaic core 25, which includes a silica- based medium 26 and multiple light non-guiding components 20 embedded in the medium, and at least one cladding 24 around the core.

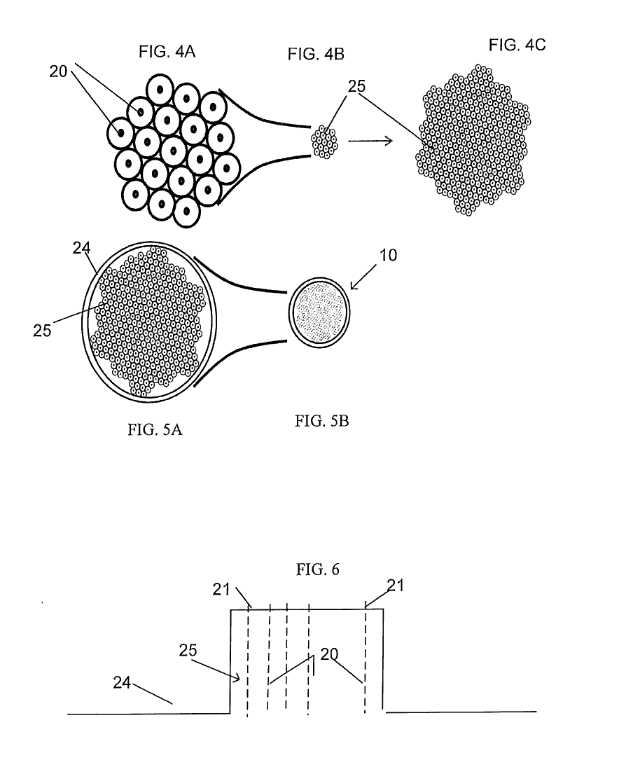

FIGS. 4 and 5 illustrate a technique for forming fiber 10 in accordance with the inventive concept. FIG. 4A illustrates the initial step of the process including forming mosaic core 25. In accordance with the initial step, multiple silica-based rods 20 are stacked together in a variety of patterns defining core 25 which may have a polygonal, round, elliptical and any other regular or irregular cross-sections. The rods 20 may be round, polygonal or have any other cross-section. Given only as an example, the initial available preform is cut into nineteen (19) longitudinal rods 20 which are placed together so that longitudinal axes of respective rods 20 extend parallel to one another. The stacked longitudinal rods 20 then are thermally treated and axially stretched to a first length so as to define a matrix of core 25 which may have a first diameter, as shown in FIG. 4B. If the first diameter is close to the desired one, then mosaic core 25 is further inserted in a tube, as shown in FIG. 5A, to undergo the last stretching and diameter reduction to the desired one. As a result, fiber 10, as shown in FIG. 5B, is formed with mosaic core 25, which has the desired cumulative refractive index ncore, and cladding 24 also with the desired refractive index n_{clad} which is smaller than that of core 25.

While reducing the initial stack of rods 20 to the desire diameter of mosaic core 25, individual rods each are reduced to the diameter that considerably inhibits and preferably completely prevents waveguiding at a five wavelength. In other words, a substantial portion of light coupled into the thus reduced individual rod expands beyond it and starts coupling with modes decoupled from neighboring rods 20. But this light is wave-guided by the silica-based medium of core 25 which is the result of fused peripheries of respective rods 20. Based on the foregoing, thus, light mostly propagates through silica which has a refractive index without the undesirable fluctuations so characteristic to prior art fibers, particularly active fibers. Because the cladding 24 is also silica-based the refractive index profile of fiber 10, if it is a step index, is characterized by a uniform index differential Δn between the core's and cladding's respective indices, as shown in FIG. 6. The initial tests show that individual rods 20 doped with a gain medium may somewhat spontaneously emit weak light, as indicated by small peaks 21, which do not negatively affect the uniformity of the refractive index profile. With the given numerical aperture, the wavelength of light incident on fiber 10 and cut-off wavelength of fundamental mode, it is easy to determine and reduce the core of each rod 20 to the size which completely prevents waveguiding making thus rods 20 each a completely none-waveguiding element.

Returning to FIG. 4B, if the first diameter is smaller than the desired core diameter, the fused bunch of FIG. 4B undergoes further elongating, cutting and additional stacking until close to the desired core diameter is reached. FIG. 4C shows exemplary core 25 including a 19 by 19 matrix, which is further treated in accordance with the steps of respective FIGS. 5A and 5B.

The original rods 20 may be configured to support propagation of a single mode or multiple transverse modes. The rods may be made from silica-glass doped with phosphate or alumina. No light amplifying ions may be doped in silica-based medium 24, i.e., fiber 25 can be passive. For many applications, it is desirable that fiber 25 is configured as a polarization maintaining fiber.

Alternatively, silica-based medium 24 may be doped with light emitters, i.e. ions of any suitable rare earth element individually or a combination of the latter. For example, the ions may include Ytterbium (“Yb”), Erbium (“Er”); Neodymium (“Nd”), Thulium (“Tm”), Samarium (“Sm”), Europium (“Eu”), Holium (“Ho”) and others. According to the inventive concept, rods 20 may be doped with the same type of light amplifying ions. Alternatively, using different preforms and, therefore rods, different types of rare earth ions can easily coexist in one core. For example, some of the rods can be doped with Er and others with Yb. Turning briefly to FIG. 3, rods 20 arranged closer to the periphery of core 25 can be doped with Sm, whereas the central region of core 25 is defined by rods 20 doped with Yb. Such a configuration allows amplifying a fundamental mode occupying substantially the central core region at about 1060 nm, whereas high order modes, mainly occupying the core periphery, are absorbed at the same wavelength since it corresponds to the absorption peak of Sm. Turning briefly to FIG. 6, small insignificant traces 32 of each doped rod 20 do not interfere with the main inventive concept of the desired refractive index of fiber 10.

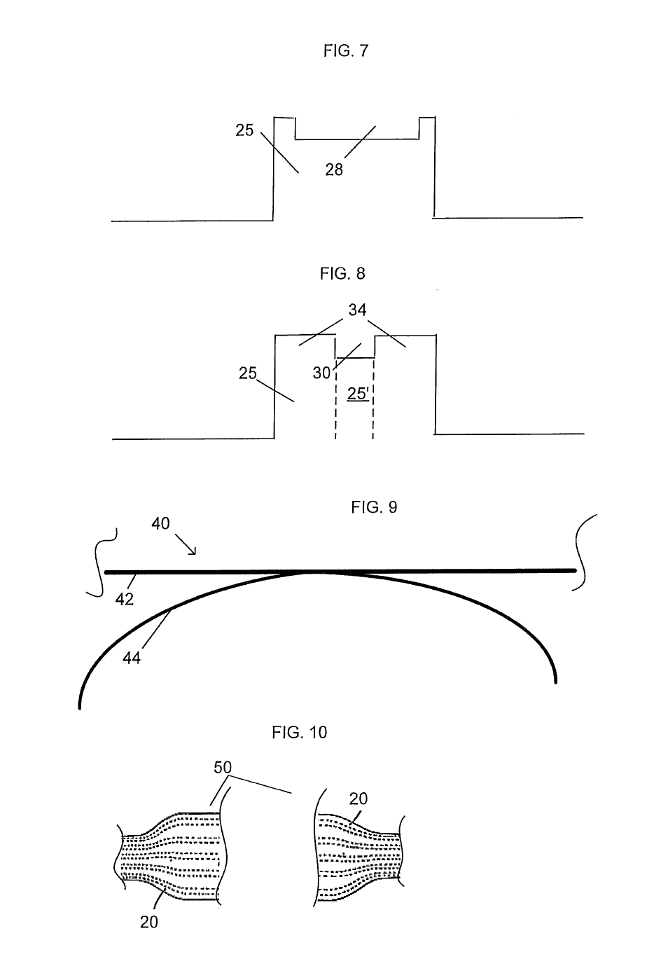

Referring to FIGS. 7 and 8, using non-amplifying dopants, it is possible to provide respective refractive index profiles characterized by a relatively large diameter central core depression 28 (or, conversely, raised peripheral region) (FIG. 7) and relatively small core depression 30 (FIG. 7B.) Both of these profiles are instrumental in widening a fundamental mode in active fibers which leads to higher thresholds for non-linear effects that are detrimental to the power scaling of fiber amplifiers.

The individual rods 20 may be doped with a high concentration of light amplifying ions of up to 5000 ppm and even higher. As one of ordinary skill in the laser arts knows, high concentrations of light amplifying ions cause lower thresholds for formation of colored centers, which are highly dangerous to fibers and their operation. In the inventive structure, however, the ion concentration is low (when compared to standard fiber which often have a dopant concentration may vary within 2000-5000 ppm range) since the area of core 25 is significantly greater than that of individual rods 20.

In accordance with a further concept of the present invention, rods 20 doped with light amplifying ions can be controllably arranged within any desired core region. For example, as shown in FIG. 8, rods 20 doped with light amplifying ions can be arranged in a central region 25′ of core 25, whereas, peripheral region 34 is defined by rods 20 that are not doped with light amplifying ions. The central core region doped with light amplifying ions is configured to amplify a fundamental mode, while peripheral region 34 populated mostly by high order modes does not provide gain to any these modes. As one of ordinary skill understands, a gain region may be arranged within any desired region of core 25 to provide amplification to any desired mode higher than the fundamental mode.

The inventive fiber 10 having different topographies. The neighboring rods 20 may be spaced from one another, for example, at a distance varying from about 7 to 17 microns. The rod diameter, for example, may vary from 2 to 3 microns. The core diameter is not limited by any particular consideration and can be constructed based on the desired requirements. The cumulative area occupied by rods 20 may vary between 5 and about 50% of the entire core area, but preferably is about 10%.

The foregoing clearly illustrates the flexibility offered by the inventive fibers. With such a variety of easily controllable physical and geometrical parameters, core 25 can be easily constructed in accordance with any given specification, polarization etc., and thus can be properly described as mosaic.

FIG. 9 illustrates a fiber laser system 40 including an active fiber 42, which is configured in accordance with the invention, and a pump delivery fiber 44. The peripheries of respective fibers 42 and 44 are mechanically coupled to one another along a length L which defines a coupling region of pump light into active fiber 42. Known on the art as the twin arrangement, the illustrated structure is particularly advantageous for high power fiber laser systems capable of outputting multi-kW output in a single fundamental mode while operating in a CW regime.

FIG. 10 illustrates mosaic core 50 which is configured in accordance with the inventive concept. The rods 20 of the fiber core are doped with light amplifying (rare earth) ions and each have a double bottleneck shaped cross-section which includes opposite cylindrical small-diameter end regions, a large diameter central region and tapered regions which bridge the opposite end regions with respective ends of the central region. The entire cross-section of the core also has a double bottleneck shape.

The input and output ends of respective rods 20 are dimensioned to not waveguide light which is coupled into the mosaic core and thus is guided by silica-based medium. In the input tapered region, the rods each begin to gradually widen expanding to the individual core size that is capable of supporting a single mode, i.e., each rod 20 supports propagating of a single mode along the central large-diameter core region. As the rods each narrow along the output tapered region, individual cores do not support propagation of light. The single modes expand beyond respective cores interacting with one another so as to form a mega mode that is further guided along the silica-based medium of the core. The fiber of FIG. 14 may be pumped in accordance with a side pumping technique shown in FIG. 13 or end pump technique, well known to one of ordinary skill.

A variety of changes of the disclosed structure may be made without departing from the spirit and essential characteristics thereof. Thus, it is intended that all matter contained in the above description should be interpreted as illustrative only and in a limiting sense, the scope of the disclosure being defined by the appended claims

1. An optical fiber, comprising:
an elongated mosaic core having a longitudinal axis and comprising a plurality of elongated individual elements each inhibiting propagation of light at a given wavelength, the individual elements being bundled together and having respective refractive indices which together determine a cumulative refractive index of the mosaic core; and
at least one cladding surrounding the mosaic core and provided with a cladding refractive index which is lower than the cumulative refractive index of the mosaic core so that the mosaic core is capable of waveguiding the light at the given wavelength,
wherein the refractive indices of respective mosaic core and cladding are controllably selected to define a predetermined refractive index profile of the optical fiber.

2. The optical fiber of claim 1, wherein the individual elements of the mosaic core each have a silica-based composition and are configured as a completely non-waveguiding element.

3. The optical fiber of claim 2, wherein the silica based composition includes silica phosphate.

4. The optical fiber of claim 2, wherein the silica-based composition includes alumina silica.

5. The optical fiber of claim 1, wherein the mosaic core is configured to support a single mode or multiple modes.

6. The optical fiber of claim 1, wherein at least some of the individual elements are selectively doped with activators, the activators being selected from the group consisting of rare earth elements and transitional metals and a combination thereof.

7. The optical fiber of claim 1, wherein at least some of the elements of the mosaic core are configured to amplify light while at least some other elements of the mosaic core are configured to absorb light.

8. The optical fiber of claim 7, wherein at least some of the individual light amplifying elements in the mosaic core are grouped together to amplify a fundamental mode, the individual light absorbing elements are arranged to suppress high order mode amplification.

9. The optical fiber of claim 1, wherein the individual elements all are passive.

10. The optical fiber of claim 7, wherein the individual elements each are a silica rod, the silica rod including a core and clad which surrounds the core.

11. The optical fiber of claim 10, wherein the cores of respective individual elements are doped with ions of rare-earth elements.

12. The optical fiber of claim 1, wherein the individual elements are configured with a uniform refractive index.

13. The optical fiber of claim 1, wherein refractive indices of respective individual elements differ from one another.

14. The optical fiber of claim 3, wherein the mosaic core is further configured with one or more individual elements having a hollow interior.

15. The optical fiber of claim 1, wherein the mosaic core has a cross-section with a circular, elliptical, polygonal, or irregular shape.

16. The optical fiber of claim 1, wherein the refractive indices of respective elements each are higher or lower or equal to that of silica.

17. An optical fiber, comprising:
a monolithic elongated mosaic core having a longitudinal axis and configured with:
a silica-based medium having a uniform refractive index, and
a plurality of coaxial elongated individual elements not waveguiding light at a given wavelength and embedded in the silica based medium and having respective refractive indices, the refractive indices of the medium and individual anti-waveguiding elements together determining a cumulative effective refractive index of the mosaic core; and
at least one cladding surrounding the mosaic core and provided with a cladding refractive index which is lower than the index of the mosaic core, so that the mosaic core waveguides the light at the given wavelength,
wherein the refractive indices of respective mosaic core and cladding are controllably selected to define a predetermined refractive index profile of the optical fiber.

18. The optical fiber of claim 17, wherein the individual anti-waveguiding elements of the mosaic core each are based on a doped silica-glass composition.

19. The optical fiber of claim 18, wherein at least some of the individual non-waveguiding elements each are based on silica phosphate compositions.

20. The optical fiber of claim 18, at least some of the individual non-waveguiding elements each are based on alumina silica compositions.

21. The optical fiber of claim 17, wherein the cladding is based on silica glass doped with light non-amplifying dopants, the activators including fluorine.

22. The optical fiber of claim 17, wherein the mosaic core is configured to support propagation of a single fundamental mode or and high-order modes of the light at the given wavelength.

23. The optical fiber of claim 17, wherein at least some of the anti-waveguiding individual elements are selectively doped with ions of one of rare earth elements or a combination of different rare-earth elements which are selected from the group consisting of Yb, Nd, Er, Mo, Eu, Tm and Sm and a combination of these.

24. The optical fiber of claim 17, wherein at least some of the anti-waveguiding individual elements of the mosaic core are configured to amplify light at the given wavelength.

25. The optical fiber of claim 24, wherein the anti-waveguiding individual light amplifying elements are grouped together to amplify substantially a fundamental mode.

26. The optical fiber of claim 17, wherein a fraction of the anti-waveguiding individual elements are configured to absorb light at the given wavelength.

27. The optical fiber of claim 26, wherein the fraction of the anti-waveguiding individual light absorbing elements suppress amplification of high order modes of the light at the give wavelength.

28. The optical fiber of claim 17, wherein the anti-waveguiding individual elements all are provided with dopants which do not amplify light but modify the effective refractive index of the core.

30. The optical fiber of claim 17, wherein at least some of the anti-waveguiding individual elements are configured with respective uniform refractive indices.

31. The optical fiber of claim 17, wherein at least some of the anti-waveguiding individual elements are configured with respective refractive indices which differ from one another.

32. The optical fiber of claim 20, wherein the mosaic core is polarization maintaining.

33. The optical fiber of claim 17, wherein the mosaic core has a cross-section with a circular, elliptical, polygonal, or irregular shape.

34. The optical fiber of claim 17, wherein the mosaic core is dimensioned with an outer diameter varying between about 20 microns to about 300 microns.

35. The optical fiber of claim 17 further comprising another cladding surrounding the one cladding and having a refractive index lower than that of the one cladding.

36. The optical fiber of claim 17, wherein the mosaic core has the effective refractive index provided with a depression along a central region thereof.

37. The optical fiber of claim 17, wherein the mosaic core has the effective refractive index provided with an elevated peripheral region.

38. The optical finer of claim 17, wherein a cumulative cross-sectional area of the individual anti-waveguiding elements is about 10% of the entire cross-sectional area of the mosaic core.

39. A fiber laser gain block, comprising:
the optical fiber of claim 24;
a pump delivery fiber, wherein the fibers have respective portions of fiber peripheries, which are detachably coupled to one another so as to define a side-pumping configuration.

40. A method of manufacturing the optical fiber of claim 1 comprising:
providing a plurality of individual elongated elements extending along respective longitudinal axes, the individual elongated elements each having a waveguiding portion embedded in a silica-glass medium, the waveguiding portions having respective refractive indices higher or equal to a refractive index of the silica-glass medium;
selectively combining the individual elements to provide a desirable cumulative refractive index, wherein the combined individual elements axially coextend to define a longitudinal mosaic core;
heating the mosaic core;
collapsing the mosaic core so that the waveguiding portions stop waveguiding; and
surrounding the mosaic core with at least one cladding having a cladding refractive index lower than the effective refractive of the mosaic core, thereby forming the optical fiber with a desired refractive index profile.
